(19) United States
(12) Patent Application Publication
(10) Pub. No.: US 2024/0388892 A1
(43) Pub. Date: Nov. 21, 2024

(54) NETWORK CAPABILITY EXPOSURE METHOD AND RELATED DEVICE

(71) Applicant: Tencent Technology (Shenzhen) Company Limited, Shenzhen (CN)

(72) Inventor: Zhuoyun ZHANG, Shenzhen (CN)

(73) Assignee: Tencent Technology (Shenzhen) Company Limited, Shenzhen (CN)

(21) Appl. No.: 18/790,223

(22) Filed: Jul. 31, 2024

Related U.S. Application Data
(63) Continuation of application No. PCT/CN2023/093762, filed on May 12, 2023.

(30) Foreign Application Priority Data
Jun. 27, 2022 (CN) 202210734112.4

(51) Int. Cl. H04W 8/22; H04W 12/06; H04W 84/04

(52) U.S. Cl. CPC H04W 8/22; H04W 12/06; H04W 84/042

(57) ABSTRACT

A network capability exposure method, performed by an application object, includes: transmitting a first request to a first exposure object of a first network and receiving a first response returned by the first exposure object, wherein the first request is a capability exposure request including an application object identifier, a notification address, first parameter information, and sharing permission information, wherein the first response includes sharing agreement information indicating whether the first exposure object agrees to share the first request with a second network, and wherein the first network and the second network are each public land mobile networks.

### CROSS-REFERENCE TO RELATED APPLICATIONS

This application is a continuation application of International Application No. PCT/CN2023/093762 filed on May 12, 2023, which claims priority to Chinese Patent Application No. 202210734112.4, filed with the China National Intellectual Property Administration on Jun. 27, 2022, the disclosures of each being incorporated herein by reference in their entireties.

### FIELD

The present disclosure relates to the field of communication technologies, and in particular, to network capability exposure.

### BACKGROUND

In related art, for the same service, if a third-party service provider desires to put forward exposure interaction requirements to a communication network to obtain a network exposure capability, it may be necessary to interact with different operators separately. In addition, interface parameters (interaction parameters) of capability information and network exposure capabilities (such as types and quality) that are exposed by different operators/different communication networks may be different. Therefore, many inconveniences and problems are brought to network capability exposure interaction of a third-party service.

### SUMMARY

Provided are a network capability exposure method, a communication device, a computer-readable storage medium, and a computer program product, optimizing for network capability exposure of a mobile communication network to third-party services.

According to some embodiments, a network capability exposure method, performed by an application object, includes: transmitting a first request to a first exposure object of a first network and receiving a first response returned by the first exposure object, wherein the first request may be a capability exposure request including an application object identifier, a notification address, first parameter information, and sharing permission information, wherein the first response may include sharing agreement information indicating whether the first exposure object agrees to share the first request with a second network, and wherein the first network and the second network may each be public land mobile networks.

According to some embodiments, a communication device includes: at least one memory configured to store computer program code; at least one processor configured to read the program code and operate as instructed by the program code, the program code including: first transmitting code configured to cause at least one of the at least one processor to transmit a first request to a first exposure object of a first network; and first receiving code configured to cause at least one of the at least one processor to receive a first response returned by the first exposure object, wherein the first request may be a capability exposure request, including: a communication device identifier; a notification address; first parameter information; and sharing permission information, wherein the first response may include sharing agreement information indicating whether the first exposure object agrees to share the first request with a second network, and wherein the first network and the second network may each be public land mobile networks.

According to some embodiments, a non-transitory computer-readable storage medium, storing computer code which, when executed by at least one processor, may cause the at least one processor to at least: transmit a first request to a first exposure object of a first network; and receive a first response returned by the first exposure object, wherein the first request may be a capability exposure request, including: an application object identifier; a notification address; first parameter information; and sharing permission information, wherein the first response may include sharing agreement information indicating whether the first exposure object agrees to share the first request with a second network, and wherein the first network and the second network may each be public land mobile networks.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a communication system architecture according to some embodiments.

FIG. 2 is a diagram of a system architecture of a 5G network according to some embodiments.

FIG. 3 is a schematic flowchart of a network capability exposure method according to some embodiments.

FIG. 4 is a schematic diagram of an interaction of a network capability exposure method according to some embodiments.

FIG. 5 is a schematic diagram of an interaction of a network capability exposure method according to some embodiments.

FIG. 6 is a schematic flowchart of a network capability exposure method according to some embodiments.

FIG. 7 is a schematic flowchart of a network capability exposure method according to some embodiments.

FIG. 8 is a schematic flowchart of a network capability exposure method according to some embodiments.

FIG. 9 is a schematic diagram of an interaction of a network capability exposure method according to some embodiments.

FIG. 10 is a schematic flowchart of a network capability exposure method according to some embodiments.

FIG. 11 is a block diagram of an application object according to some embodiments.

FIG. 12 is a block diagram of a first exposure object of a first public land mobile network according to some embodiments.

FIG. 13 is a block diagram of a second exposure object of a second public land mobile network according to some embodiments.

FIG. 14 is a schematic diagram of a structure of a communication device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions according to some embodiments may be applied to various communication systems, for example, a Global System for Mobile Communications (GSM) system, a code division multiple access (CDMA) system, a wideband code division multiple access (WCDMA) system, a general packet radio service (GPRS), a long term evolution (LTE) system, an LTE frequency division duplex (FDD) system, LTE time division duplex (TDD), a universal mobile communication system (UMTS), a worldwide interoperability for microwave access (WiMAX) communication system, a 5G system, or a future evolved mobile communication system.

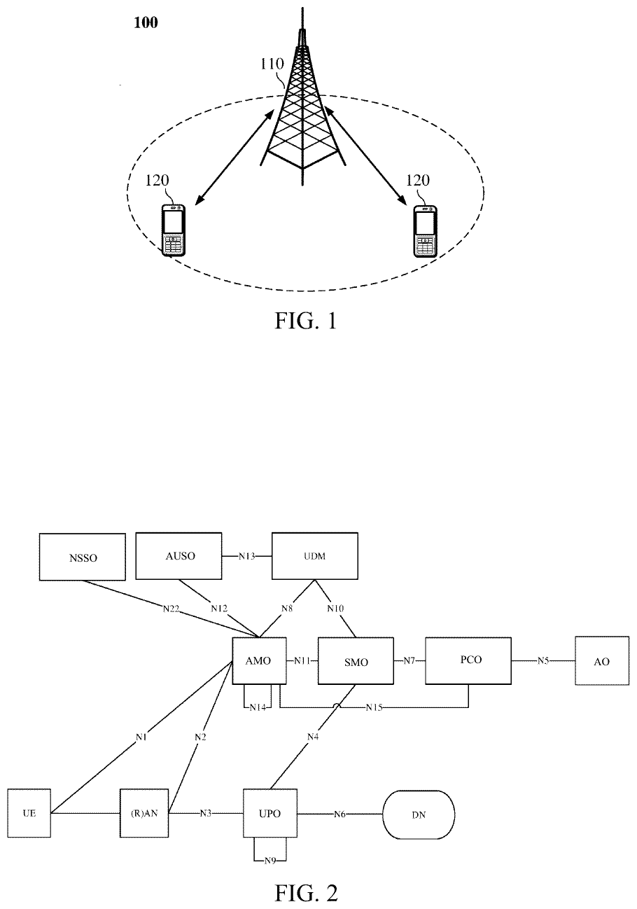

For example, a communication system 100 applied to some embodiments is shown in FIG. 1. The communication system 100 may include a network device 110. The network device 110 may be a device that communicates with a terminal 120 (or referred to as a communication terminal or a terminal). The network device 110 may provide communication coverage for a geographic area and may communicate with terminals located within the geographic area. In some embodiments, the network device 110 may be a base transceiver station (BTS) in the GSM system or the CDMA system, a base station (NodeB, NB) in the WCDMA system, an evolved NodeB (eNB or eNodeB) in the LTE system, a base station in a 5G communication system, or a wireless controller in a cloud radio access network (CRAN). Alternatively, the network device may be a mobile switching center, a relay station, an access point, a vehicle-mounted device, a wearable device, a hub, a switch, a bridge, a router, a network-side devices in a 5G network, a network device in a future evolved public land mobile network (PLMN), or the like.

The communication system 100 further includes at least one terminal 120 located within the coverage of the network device 110. As used herein, the “terminal” includes, but is not limited to, connections via wired lines, such as connections via a public switched telephone network (PSTN), a digital subscriber line (DSL), a digital cable, and a direct cable; and/or another data connection/network; and/or via a wireless interface, such as for a cellular network, a wireless local area network (WLAN), a digital television network such as a DVB-H network, a satellite network, and an AM-FM broadcast transmitter; and/or an apparatus of another terminal configured to receive/transmit communication signals; and/or an Internet of things (IoT) device. A terminal configured to communicate through a wireless interface may be referred to as a “wireless communication terminal”, a “wireless terminal”, or a “mobile terminal”. An example of the mobile terminal includes, but is not limited to, a satellite or a cellular phone; a personal communication system (PCS) terminal that can combine cellular radiotelephone with data processing, fax, and data communication capabilities; a PDA that may include a radiotelephone, a pager, Internet/Intranet access, a Web browser, a planner, a calendar, and/or a global positioning system (GPS) receiver; and a conventional laptop and/or handheld receiver or another electronic device including a radiotelephone transceiver. The terminal may be referred to as an access terminal, user equipment (UE), a subscriber unit, a subscriber station, a mobile station, a mobile console, a remote station, a remote terminal, a mobile device, a user terminal, a terminal, a wireless communication device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal in the 5G network or a terminal in the future evolved PLMN, or the like.

In some embodiments, device to device (D2D) communication may be performed between terminals 120.

FIG. 1 exemplarily shows a network device and two terminals. In some embodiments, the communication system 100 may include a plurality of network devices. Other quantities of terminals may be included in the coverage of each network device.

In some embodiments, the communication system 100 may further include another network element such as a policy control network element or an access mobility management network element.

In some embodiments, a device having a communication function in a network/system may be referred to as a communication device. Using the communication system 100 shown in FIG. 1 as an example, the communication device may include the network device 110 and the terminal 120 that have communication functions. The network device 110 and the terminal 120 may include the devices described above.

The terms “system” and “network” may be used interchangeably. The term “and/or” used herein describes only an association relationship between associated objects and represents that three relationships may exist. For example, A and/or B may represent the following three cases: Only A exists, both A and B exist, and only B exists.

FIG. 2 is a diagram of a system architecture of a 5G network according to some embodiments. As shown in FIG. 2, devices included in a 5G network system include a terminal (UE), a radio access network (RAN), a user plane object (UPO) (sometimes referred to as a “user plan function” (UPF) by the 3rd Generation Partnership Project (3GPP), for example), a data network (DN), an access and mobility management object (AMO) (sometimes referred to as an “access and mobility management function” (AMF) by the 3GPP, for example), a session management object (SMO) (sometimes referred to as a “session management function” (SMF) by the 3GPP, for example), a policy control object (PCO) (sometimes referred to as a “policy control function” (PCF) by the 3GPP, for example), an application object (AO) (sometimes referred to as an “application function” (AF) by the 3GPP, for example), an authentication server object (AUSO) (sometimes referred to as an “authentication server function” (AUSF) by the 3GPP, for example), and a unified data management (UDM).

The “network capability exposure” and “capability exposure” mentioned according to some embodiments refer to abstracting and exposing capabilities of a network (such as the 5G network, but the present disclosure is not limited thereto), to achieve friendly interoperability and mutually beneficial cooperation between an operator network and a third-party service provider, thereby satisfying richer and more flexible mobile network capabilities exposed to a third party.

Capability exposure supports external exposure of network capabilities. For example, an externally exposed service capability may include, but is not limited to, the following:

(1) Network detection capability exposure: It refers to that a network provides a third party with a capability to detect a congestion status of an area of the network, detect a movement range of a terminal, or the like, and detection event information is exposed externally via a network exposure object (NEO, or “exposure object”) (sometimes referred to as a “network exposure function” (NEF) by the 3GPP, for example).

(2) Network basic service capability exposure: It refers to that a network provides a basic short message service message capability, a voice capability, billing capability, and the like to a third party.

(3) Network control capability exposure: It refers to that a network provides a third party with a capability, such as Quality of Service (QoS) guarantee.

(4) Network information capability exposure: It refers to that a network provides internal network information to a third party, including real-time terminal connection attributes, terminal location information, non-real-time big data analysis information, or the like.

(5) Network slice orchestration and management capability exposure: It refers to that a network exposes a life cycle management capability of a network slice to a third party.

(6) Reverse capability exposure: It refers to that a third party may expose valuable information to a mobile network, such as a terminal communication mode and mobility information, for network optimization and management.

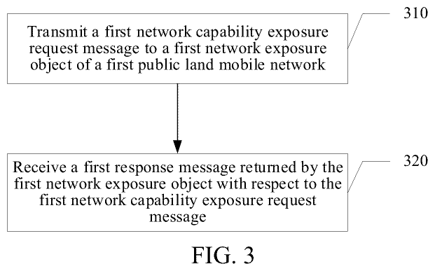

FIG. 3 is a schematic flowchart of a network capability exposure method according to some embodiments. In FIG. 3, the method may be performed by any communication device. The communication device may be, for example, the AO in FIG. 2, but the present disclosure is not limited thereto.

As shown in FIG. 3, the method, according to some embodiments, may include the following operations.

310: Transmit a first request that is, for example, a network capability exposure request message, to a first exposure object (the first exposure object is denoted as an NEO-1 in the following description) of a first network, that is, for example, a first public land mobile network (PLMN) (the first network is denoted as a PLMN A in the following description).

In some embodiments, the first request refers to a message that is transmitted by the AO to the NEO-1 of PLMN A and that is configured for requesting PLMN A to expose a network capability to the AO. The first request may include an application object identifier (denoted as an AO ID) of an application object, a notification address, first parameter information, and sharing permission information.

In some embodiments, the notification address refers to a notification address, or an address to which exposed network capability information is returned based on PLMN A and/or PLMN B allowing to expose a network capability to the AO. For example, the address may be an Internet protocol (IP) address of the AO. The NEO-1 may return a capability exposure notification message of PLMN A to the AO based on the notification address, and/or an NEO-2 may directly or indirectly return a capability exposure notification message of PLMN B to the AO based on the notification address.

In some embodiments, the first parameter information is first parameter network capability exposure request parameter information, or refers to what network capabilities the AO expects to expose to the AO. First parameter information may be set according to actual needs. For example, the first parameter information may include an event identifier (Event ID, here for differentiation, it is referred to as the first event identifier). The first parameter information may further include condition information for information reporting (for differentiation, it is here referred to as first reporting condition information) and the like.

In some embodiments, the first parameter information may further include traffic flow template information.

In some embodiments, the traffic flow template information may include one or more of the following: a source IP address (a source network address), source port number, a destination IP address (destination network address), a destination port number, a fully qualified domain name (FQDN), and an application identity (APP ID), and the like of a target traffic flow.

In some embodiments, the target traffic flow refers to a traffic flow formed by transmission of an uplink data packet sent by the terminal and/or a downlink data packet sent by a service server in a network for one or more target services. The target service may be set according to actual needs.

In some embodiments, the sharing permission information may be capability exposure request sharing information and may be configured for indicating whether the AO allows the first request to be shared with a PLMN other than the requested PLMN A.

If the sharing permission information indicates that the application object allows to share a capability exposure request, the first request may further include a second network identifier (the second network, that is, for example, a second public land mobile network, is denoted as a PLMN B), indicating that sharing of the capability exposure request is allowed. The second network identifier refers to any identification information that may uniquely identify the PLMN B. The second network may be any one or more PLMNs other than the PLMN A.

In some embodiments, based on the sharing permission information indicating the application object allows to share the capability exposure request, the first request may not include the second network identifier. The NEO-1 may determine, based on the sharing permission information carried in the first request and based on negotiation between the PLMN A and other PLMNs, which PLMN the network capability exposure request of the AO is shared with.

320: Receive a first response message returned by the first exposure object with respect to the first request.

In some embodiments, based on the NEO-1 of the PLMN A receiving the first request transmitted by the AO, authentication and verification may be performed on the first request. The first response message is generated based on an authentication and verification result, and the first response message is returned to the AO corresponding to the AO ID.

The first response message may include indication information about “whether to agree the first request[.]” If the authentication and verification result is that the authentication and verification is passed, the indication information about “whether to agree the first request” may be “agree the first request.” On the contrary, if the authentication and verification result is failed, the indication information about “whether to agree the first request” may be “disagree the first request[.]” If the NEO-1 rejects the first request, the first response message may further include a rejection cause value.

In some embodiments, the first response message may include sharing agreement information. The sharing agreement information may be sharing agreement information and may be configured for indicating whether the first exposure object agrees to share a capability exposure request with a second network, that is, for example, a second public land mobile network, corresponding to a second network identifier.

In some embodiments, the sharing agreement information and the indication information about “whether to agree the first request” may share the same indication information. For example, the same field is used. A first value is taken to indicate that the NEO-1 rejects the first request. In other words, neither the PLMN A nor the PLMN B agrees to expose network capabilities to the AO. A second value is taken to indicate that the NEO-1 only agrees the PLMN A to exposure a network capability to the AO and does not support sharing the first request to the PLMN B. A third value is taken to indicate that the NEO-1 agrees the PLMN A to exposure the network capability to the AO and supports sharing the first request to the PLMN B. A fourth value is taken to indicate that the NEO-1 does not agree the PLMN A to expose the network capability to the AO, but supports sharing the first request to the PLMN B. The sharing agreement information and the indication information about “whether to agree to the first request” may be different indication information separately. For example, two fields are used to indicate respectively, one field is configured for indicating whether the NEO-1 passes authentication and verification on the first request, and the other field is configured for indicating whether the PLMN A in which the NEO-1 is located supports sharing the first request to the PLMN B. This is not limited in the present disclosure.

In some embodiments, the method may further include: receiving a second response message if the sharing agreement information indicates that the first exposure object agrees to share the capability exposure request with the second network.

In some embodiments, if the NEO-1 agrees to share the first request with the second network, the NEO-1 may inform the AO based on sharing agreement information. In addition, the NEO-1 may generate a second request that is, for example, a network capability exposure request message, based on the first request, and transmit the second request to an NEO-2 (a second exposure object) of the PLMN B. Based on the NEO-2 receiving the second request, the NEO-2 may perform authentication and verification on the second request to generate a second response message based on an authentication and verification result. The second response message includes exposure agreement information that is, for example, capability exposure indication information about “whether to agree the second request[.]” If the authentication and verification result is that the authentication and verification is passed, the exposure agreement information indicates that “the NEO-2 of the PLMN B agrees the second request[.]” Otherwise, the exposure agreement information indicates that “the NEO-2 of the PLMN B does not agree the second request[.]”

In some embodiments, the method may further include: receiving a capability exposure notification message of the second network if the exposure agreement information indicates that the second exposure object agrees to expose the network capability to the application object, the capability exposure notification message including exposure information content.

In some embodiments, based on the NEO-2 agreeing to expose a network capability of the PLMN B to the AO, the AO may receive a capability exposure notification message of the PLMN B. The capability exposure notification message is configured for indicating related information of a network capability exposed, to the AO, by the PLMN B. For example, the capability exposure notification message may include exposure information content to be configured for indicating what exposure network capability is.

In some embodiments, the receiving a capability exposure notification message of the second network may include: receiving the capability exposure notification message from the first exposure object or the second exposure object.

In some embodiments, based on learning the notification address, the NEO-2 may directly transmit the capability exposure notification message of the PLMN B to the AO. In some embodiments, if the NEO-2 and the NEO-1 may communicate with each other directly, the NEO-2 may first transmit the capability exposure notification message of the PLMN B to the NEO-1, and then the capability exposure notification message of the PLMN B is transmitted to the AO via the NEO-1.

In some embodiments, the receiving a capability exposure notification message of the second network may include: receiving the capability exposure notification message from a first interworking gateway of the first network or a second interworking gateway of the second network.

In some embodiments, if the NEO-1 and the NEO-2 communicate with each other via an interworking gateway, the NEO-2 may first transmit the capability exposure notification message of the PLMN B to an interworking gateway-2 (the second interworking gateway) of the PLMN B, and then the interworking gateway-2 transmits the capability exposure notification message of the PLMN B to an interworking gateway-1 (the first interworking gateway) of the PLMN A, and then the interworking gateway-1 transmits the capability exposure notification message of the PLMN B to the NEO-1, and then the capability exposure notification message of the PLMN B is transmitted to the AO via the NEO-1.

In some embodiments, the NEO-2 may first transmit the capability exposure notification message of the PLMN B to the interworking gateway-2 (the second interworking gateway) of the PLMN B, and then the interworking gateway-2 transmits the capability exposure notification message of the PLMN B to the AO.

In some embodiments, the NEO-2 may first transmit the capability exposure notification message of the PLMN B to the interworking gateway-2 (the second interworking gateway) of PLMN B, then the interworking gateway-2 transmits the capability exposure notification message of the PLMN B to the interworking gateway-1 (the first interworking gateway) of the PLMN A, and then the interworking gateway-1 transmits the capability exposure notification message of the PLMN B to the AO.

In some embodiments, if the sharing permission information in the first request indicates that the AO does not allow to share a capability exposure request, the NEO-1 performs authentication and verification on the first request to generate the first response message, the first response message including indication information about “whether to agree the first request[.]” If the indication information about “whether to agree the first request” indicates that the NEO-1 rejects the first request, this operation is ended. If the indication information about “whether to agree the first request” indicates that the NEO-1 agrees the first request, a capability exposure notification message of the PLMN A corresponding to the first event identifier is transmitted to the AO based on the NEO-1 detecting the first reporting condition information is satisfied.

In some embodiments, if sharing agreement information in the first response message indicates that the NEO-1 does not agree to share a capability exposure request with the PLMN B, and the indication information about “whether to agree the first request” in the first response message indicates that the NEO-1 rejects the first request, this operation is ended. If the indication information about “whether to agree the first request” indicates that the NEO-1 agrees the first request, a capability exposure notification message of the PLMN A corresponding to the first event identifier is transmitted to the AO based on the NEO-1 detecting the first reporting condition information is satisfied.

In the network capability exposure method provided in implementations of the present disclosure, based on the application object transmitting the first request to the first exposure object of the first network, sharing permission information is carried in the first request, to indicate, based on the sharing permission information, whether the application object allows to share a capability exposure request, so that the first exposure object of the first network can return, based on the sharing permission information carried in the first request, sharing agreement information included in the first response message to the application object, and the sharing agreement information indicates whether the first exposure object agrees to share the capability exposure request to the second network. In other words, the first exposure object of the first network may serve as an agent of the application object, and the first network and the second network may respectively serve as mobile communication networks provided by two different operators or two different mobile communication networks deployed by the same operator, so that the application object does not need to interact with different mobile communication networks separately, and the application object only needs to put forward an interaction requirement for capability exposure to a mobile communication network of one of the operators based on the first request. A network capability exposure mechanism is optimized to simplify an interaction process between a third-party service provider and different mobile communication networks and improve interaction efficiency. In addition, the third-party service provider no longer needs to consider differences between interaction parameters and network exposure capabilities of different mobile communication networks. This brings convenience to network capability exposure and interaction of a third-party service.

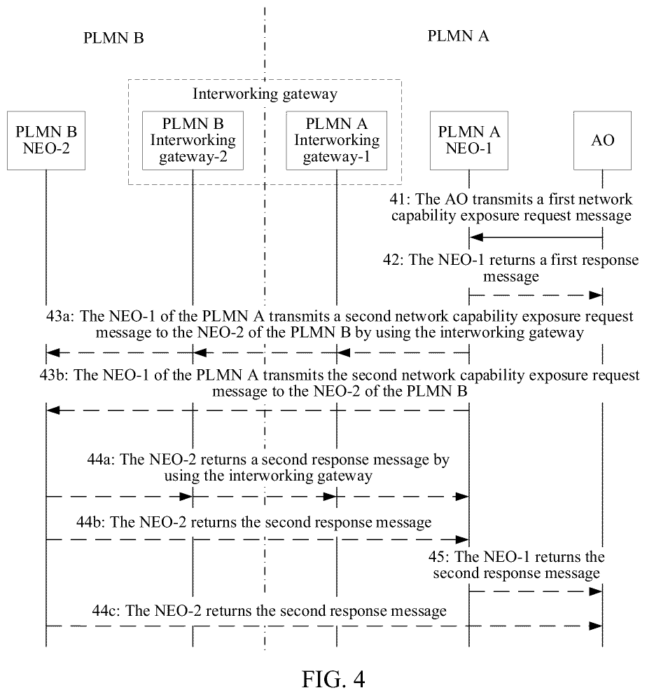

In some embodiments of FIG. 4, the AO actively requests to share a capability exposure request. In a system architecture of a scenario shown in FIG. 4, an application object (such as an AO), a first exposure object (such as an NEO-1), and a second exposure object (such as an NEO-2) are included. These network elements are configured to perform the network capability exposure method. The method may include the following operations.

41: The AO transmits a first request that is, for example, a network capability exposure request message, to the NEO-1 of a PLMN A.

In some embodiments, the AO transmits the first request to the NEO-1 of the PLMN A. The first request may include an AO ID of the AO, a notification address, first parameter information (such as a first Event ID and first reporting condition information), may further include traffic flow template information and sharing permission information (configured for indicating whether a capability exposure request is allowed to be shared with information of other PLMNs), and may further include a PLMN identifier indicating that the capability exposure request is allowed. A PLMN B is used herein as an example for description.

42: The NEO-1 returns a first response message to the AO.

In some embodiments, the NEO-1 receives the first request, performs authentication and verification on the first request transmitted by the AO, and returns the first response message to the AO. The first response message may include indication information about “whether to agree the first request[,]” and if rejected, the first response message may further include a rejection cause value.

If the NEO-1 only agrees this PLMN A to expose a network capability to the AO and does not support sharing the first request with the PLMN B, the sharing agreement information in the first response message in 42 may indicate the NEO-1 to reject to share a capability exposure request to the PLMN B. The first response message may further include a cause value for rejecting to share the capability exposure request (for example, this PLMN A does not support sharing, or the PLMN B does not support sharing). There is no need to perform subsequent 43 to 45.

In some embodiments, 43a: The NEO-1 of the PLMN A transmits a second request that is, for example, a network capability exposure request message, to the NEO-2 of the PLMN B by using an interworking gateway-1 of the PLMN A and an interworking gateway-2 of the PLMN B separately.

For example, the NEO-1 may generate the second request based on the first request, and transmit the second request to the interworking gateway-1 of the PLMN A. The second request may include an identifier of a target PLMN B (for example, a second network identifier of a second network), an identifier of this PLMN A (for example, a first network identifier of a first network), an AO ID, the notification address, the second parameter information, and the like. The second parameter information may be second network capability exposure request parameter information, may include a second Event ID, and may further include second reporting condition information. The second parameter information may further include traffic flow template information.

In some embodiments, the second parameter information and the first parameter information may be the same, may be different, or may be partially the same. The second Event ID may be the same as the first Event ID or may be different from the first Event ID. The first reporting condition information and the second reporting condition information may be the same or may be different. The second parameter information may be determined by the NEO-1 based on the first parameter information, as well as various factors such as a network capability that the PLMN B can expose and a required interface parameter. It is not necessary for the AO (such as a third-party service provider) to consider differences between interaction parameters and network exposure capabilities of mobile communication networks provided by different operators. Instead, the PLMN A serves as an agent for the AO to negotiate with another PLMN B.

The interworking gateway-1 transmits the second request to the interworking gateway-2 of the PLMN B based on the identifier of the target PLMN B included in the second request (the two PLMNs may pass a plurality of Interworking gateways, and the quantity is not limited). The interworking gateway-2 transmits the second request to the NEO-2 of the PLMN B.

In some embodiments, 43b: The NEO-1 of the PLMN A transmits the second request to the NEO-2 of the PLMN B.

In some embodiments, based on NEOs of two PLMNs interacting directly, the NEO-1 may directly transmit the second request to the NEO-2.

In some embodiments, 44a: The NEO-2 returns a second response message to the NEO-1 by using the interworking gateway-2 of the PLMN B and the interworking gateway-1 of the PLMN A separately.

In some embodiments, the NEO-2 performs authentication and verification on the second request, and returns the second response message to the interworking gateway-2 of the PLMN B. The second response message may include identification of a target PLMN A (for example, a first network identifier of a first network), identification of this PLMN B (for example, a second network identifier of a second network), and exposure agreement information. The exposure agreement information may be capability exposure indication information and may indicate whether the NEO-2 agrees to expose a network capability to the AO. If rejected, the second response message may include a rejection cause value.

The interworking gateway-2 forwards the second response message to the interworking gateway-1 of the PLMN A based on the identification of the target PLMN A. The interworking gateway-1 transmits the second response message to the NEO-1.

In some embodiments, 44b: The NEO-2 returns the second response message to the NEO-1.

In some embodiments, based on the NEOs of two PLMNs interacting directly, the NEO-2 may directly transmit the second response message to the NEO-1.

In some embodiments, 45: The NEO-1 returns the second response message to the AO.

In some embodiments, based on receiving the second response message, the NEO-1 may forward the second response message to the AO.

In some embodiments, 44c: The NEO-2 returns the second response message to the AO based on the notification address directly.

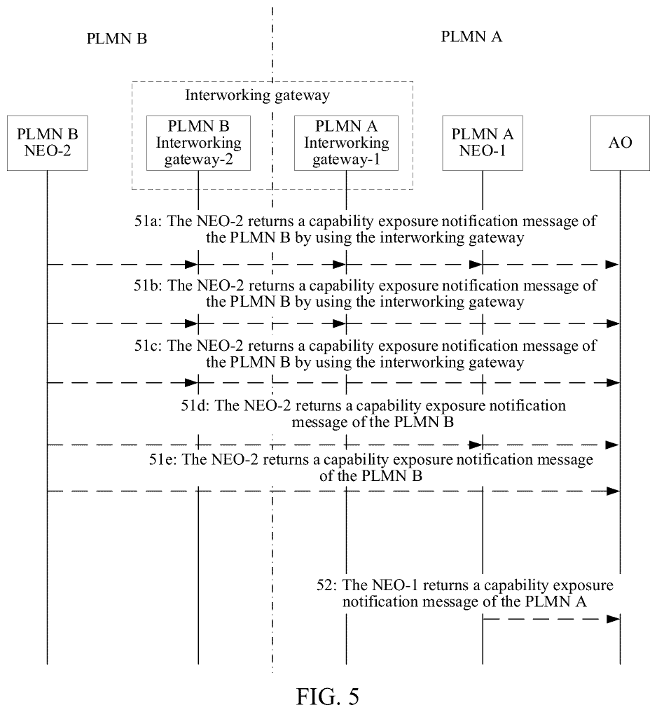

As shown in FIG. 5, in a system architecture of a scenario shown in FIG. 5, an application object (such as an AO), a first exposure object (such as an NEO-1), and a second exposure object (such as an NEO-2) are included. These network elements are configured to perform the network capability exposure method in some embodiments.

The method in some embodiments may further include: generating a capability exposure notification message of the PLMN B based on network information of the PLMN B in FIG. 4 satisfying second reporting condition information. A path of the capability exposure notification message of PLMN B depends on whether an interworking gateway may directly transmit a message to a notification address of PLMN B in FIG. 4, and there may be some processes as follows.

51a: The NEO-2 returns the capability exposure notification message of the PLMN B to the AO by using an interworking gateway-2 of the PLMN B, an interworking gateway-1 of a PLMN A, and the NEO-1 separately.

In some embodiments, the NEO-2 may transmit the capability exposure notification message of the PLMN B to the interworking gateway-2 of the PLMN B based on the network information of the PLMN B in FIG. 4 satisfying the second reporting condition information. The capability exposure notification message of the PLMN B may include identification of a target PLMN A, identification of this PLMN B, a notification address, and exposure information content of the PLMN B. The interworking gateway-2 transmits the capability exposure notification message of the PLMN B to an interworking gateway-1 of the PLMN A, the interworking gateway-1 transmits the capability exposure notification message of the PLMN B to the NEO-1, and the capability exposure notification message of the PLMN B is finally transmitted to the notification address.

In some embodiments, 51b: The NEO-2 returns the capability exposure notification message of the PLMN B to the AO by using the interworking gateway-2 of the PLMN B and the interworking gateway-1 of the PLMN A separately.

In some embodiments, the NEO-2 may transmit the capability exposure notification message of the PLMN B to the interworking gateway-2 of the PLMN B based on the network information of the PLMN B satisfying the second reporting condition information. The capability exposure notification message of the PLMN B includes identification of a target PLMN A, identification of this PLMN B, a notification address, and exposure information content of the PLMN B. The interworking gateway-2 transmits the capability exposure notification message of the PLMN B to an interworking gateway-1 of the PLMN A, and the interworking gateway-1 transmits the capability exposure notification message of the PLMN B to the notification address.

In some embodiments, 51c: The NEO-2 returns the capability exposure notification message of the PLMN B to the AO by using the interworking gateway-2 of the PLMN B.

In some embodiments, the NEO-2 may transmit the capability exposure notification message of the PLMN B to the interworking gateway-2 of the PLMN B based on the network information of the PLMN B satisfying second reporting condition information. The capability exposure notification message of the PLMN B includes identification of this PLMN B, a notification address, and exposure information content of the PLMN B. The interworking gateway-2 transmits the capability exposure notification message of the PLMN B to the notification address.

In some embodiments, 51d: The NEO-2 transmits the capability exposure notification message of the PLMN B to the NEO-1, and the NEO-1 returns the capability exposure notification message of the PLMN B to the AO.

In some embodiments, 51e: The NEO-2 transmits the capability exposure notification message of the PLMN B to the AO.

Based on NEOs of two PLMNs interacting directly, the NEO-2 may directly transmit the capability exposure notification message of the PLMN B to the NEO-1, and the NEO-1 transmits the capability exposure notification message of the PLMN B to the AO. Alternatively, the NEO-2 directly transmits the capability exposure notification message of the PLMN B to the AO.

In some embodiments, 52: The NEO-1 returns a capability exposure notification message of the PLMN A to the AO.

In some embodiments, the NEO-1 may transmit the capability exposure notification message of the PLMN A to the notification address based on network information of the PLMN A satisfying first reporting condition information. The capability exposure notification message of the PLMN A includes exposure information content of the PLMN A.

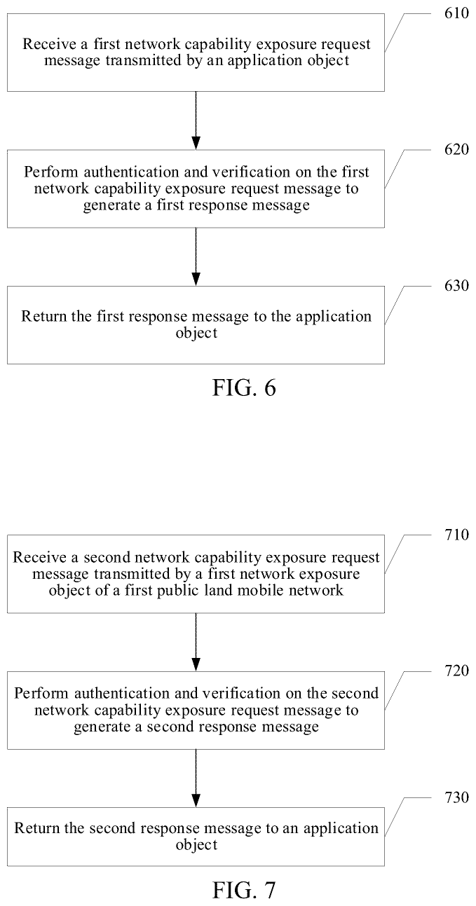

FIG. 6 is a schematic flowchart of a network capability exposure method according to some embodiments.

As shown in FIG. 6, the method may be performed by a first exposure object of a first network that is, for example, a first public land mobile network. The method, according to some embodiments, may include the following operations.

610: Receive a first request that is, for example, a network capability exposure request message, transmitted by an application object.

In some embodiments, the first request may include application object identifier, a notification address, first parameter information, and sharing permission information.

If the sharing permission information indicates that the application object allows to share the capability exposure request, the first request may further include a second network identifier of a second network that is, for example, a second public land mobile network, indicating that sharing of the capability exposure request is allowed.

620: Perform authentication and verification on the first request to generate a first response message.

The first response message may include sharing agreement information. The sharing agreement information may be configured for indicating whether the first exposure object agrees to share a capability exposure request with a second network that is, for example, a second public land mobile network.

630: Return the first response message to the application object.

In some embodiments, the method may further include: transmitting a second request that is, for example, a network capability exposure request message, to a second exposure object of the second network if the sharing agreement information indicates that the first exposure object agrees to share the capability exposure request with the second network, the second request including the application object identifier, the notification address, and second parameter information; receiving a second response message with respect to the second request, the second response message including exposure agreement information, and the exposure agreement information being configured for indicating whether the second exposure object agrees to expose a network capability to the application object; and forwarding the second response message to the application object.

In some embodiments, if indication information about “whether to agree the second request” indicates that the NEO-2 agrees the second request, the NEO-2 transmits, to the AO, exposure agreement information of a PLMN B corresponding a second event identifier by using the second response message.

In some embodiments, the second parameter information may further include second reporting condition information.

In some embodiments, the transmitting a second request to a second exposure object of the second network includes: transmitting the second request to a first interworking gateway of the first network. The second request further includes a second network identifier of a second network and a first network identifier of a first network.

The second request may be configured for indicating the first interworking gateway to transmit, based on the second network identifier, the second request to a second interworking gateway of the second network.

The second request may be further configured for indicating the second interworking gateway to transmit the second request to the second exposure object.

In some embodiments, the method may further include: receiving a capability exposure notification message of the second network if the exposure agreement information indicates that the second exposure object agrees to expose the network capability to the application object, the capability exposure notification message including exposure information content; and transmitting the capability exposure notification message to the application object.

FIG. 7 is a schematic flowchart of a network capability exposure method according to some embodiments.

As shown in FIG. 7, the method may be performed by a second exposure object of a second network that is, for example, a second public land mobile network. The method may include the following operations.

710: Receive a second request transmitted by a first exposure object of a first network that is, for example, a first public land mobile network.

The second request may include an application object identifier, identification of a PLMN B, a notification address, and second parameter information.

720: Perform authentication and verification on the second request to generate a second response message. The second response message may include exposure agreement information, and the exposure agreement information may be configured for indicating whether the second exposure object agrees to expose a network capability to an application object.

730: Return the second response message to the application object.

In some embodiments, the method may further include: generating a capability exposure notification message of the second network if the exposure agreement information indicates that the second exposure object agrees to expose the network capability to the application object, the capability exposure notification message including exposure information content; and transmitting the capability exposure notification message of the second network to the application object.

In the network capability exposure method provided according to some embodiments, an AO may actively request to share a capability exposure request to a PLMN other than the requested PLMN.

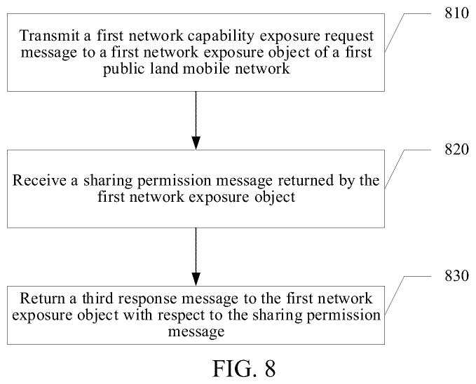

FIG. 8 is a schematic flowchart of a network capability exposure method according to some embodiments.

As shown in FIG. 8, the method may be performed by an application object. The method may include the following operations.

810: Transmit a third request that is, for example, a network capability exposure request message, to a first exposure object of a first network that is, for example, a first public land mobile network.

The third request may include an application object identifier, a notification address, and first parameter information.

820: Receive a sharing permission message returned by the first exposure object.

In some embodiments, based on the NEO-1 receiving the third request transmitted by the AO, the third request does not carry sharing permission information, in other words, the AO does not actively request to share a capability exposure request. However, the NEO-1 may transmit a sharing permission message to the AO. The sharing permission message may be a capability exposure request sharing message and may include a second network identifier indicating that sharing of the capability exposure request is allowed. Using the foregoing PLMN B as an example, the AO is asked whether to agree to transmit a capability exposure request to the PLMN B.

830: Return a third response message to the first exposure object with respect to the sharing permission message.

After receiving the sharing permission message transmitted by the NEO-1, the AO may generate the third response message. The third response message may include sharing agreement information. The sharing agreement information may be capability exposure request sharing indication information and may be configured for indicating whether the application object agrees to share a capability exposure request with a second network that is, for example, a second public land mobile network, corresponding to the second network identifier.

In some embodiments, the method may further include: receiving a capability exposure notification message of the second network if the sharing agreement information indicates that the application object agrees to share the capability exposure request with the second network, the capability exposure notification message of the second network including exposure information content.

In some embodiments, if the sharing agreement information indicates that the AO does not agree to share a capability exposure request to the PLMN B, the AO does not receive the capability exposure notification message transmitted by the PLMN B.

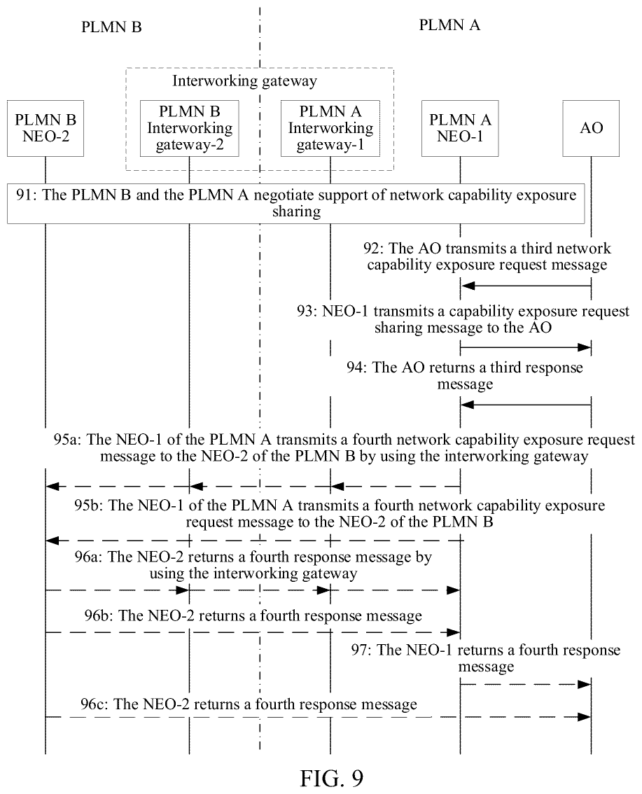

FIG. 9 shows that, according to some embodiments, an NEO (using an NEO-1 as an example) actively requests to share capability exposure to an AO.

As shown in FIG. 9, in a system architecture of a scenario shown in FIG. 9, an application object (such as an AO), a first exposure object (such as an NEO-1), and a second exposure object (such as an NEO-2) are included. These network elements are configured to perform the network capability exposure method. The method according to some embodiments may include the following operations.

91: A PLMN B and a PLMN A negotiate support of network capability exposure sharing.

In some embodiments, the PLMN A and the PLMN B negotiate whether to support network capability exposure sharing. Content of the negotiation may include whether to support capability exposure sharing for an AO and capability exposure sharing for a type of service, an Event ID supporting network capability exposure sharing, a reporting condition supporting network information exposure, and the like. The content of the negotiation is referred to as network capability exposure sharing negotiation information. Network elements that support negotiation may be NEOs of two PLMNs, network management systems of two PLMNs, or the like. This is not limited in the present disclosure.

In one situation, the NEO-1 transmits a negotiation message to the NEO-2 to negotiate support of network capability exposure sharing. The negotiation message carries identification of AO, traffic flow template information, an Event ID, a reporting condition for network information exposure, and the like. The NEO-2 returns a response message to inform the NEO-1 whether to agree the negotiation.

In another situation, the NEO-2 transmits a negotiation message to the NEO-1 to negotiate support of network capability exposure sharing. The negotiation message carries identification of AO, traffic flow template information, an Event ID, a reporting condition for network information exposure, and the like. The NEO-1 returns a response message to inform the NEO-2 whether to agree the negotiation.

For example, the NEO-1 may transmit a negotiation message to the NEO-2 by using an interworking gateway-1 and an interworking gateway-2 to negotiate support of network capability exposure sharing. The negotiation message carries at least one of an AO ID, traffic flow template information, an Event ID, a reporting condition for network information exposure, and the like. The NEO-2 may return a response message by using the interworking gateway-2 and the interworking gateway-1 to inform the NEO-1 whether to agree the negotiation.

For another example, the NEO-2 may transmit a negotiation message to the NEO-1 by using an interworking gateway-2 and an interworking gateway-1 to negotiate support of network capability exposure sharing. The negotiation message carries at least one of an AO ID, traffic flow template information, an Event ID, a reporting condition for network information exposure, and the like. The NEO-1 returns a response message by using the interworking gateway-1 and the interworking gateway-2 to inform the NEO-2 whether to agree the negotiation.

92: The AO transmits a third request to the NEO-1 of the PLMN A.

Based on the AO transmitting the third request to the NEO-1, the third request may include the AO ID, a notification address, first parameter information, and the like. The first parameter information may include a first Event ID, and may further include first reporting condition information. The first parameter information may further include traffic flow template information.

93: The NEO-1 of the PLMN A returns a sharing permission message to the AO.

The sharing permission message is transmitted to the AO based on the third request transmitted by the AO satisfying capability exposure that may be shared in network capability exposure sharing negotiation information. The sharing permission message may include PLMN B sharing an identifier (a second network identifier) indicating that sharing of a capability exposure request is allowed. If a capability exposure request can be shared with a plurality of PLMNs, an identifier of the plurality of PLMNs is returned.

94: The AO returns a third response message to the NEO-1 of the PLMN A.

After receiving the sharing permission message, the AO may return the third response message to the NEO-1. The third response message may include sharing agreement information. The sharing agreement information may be capability exposure request sharing indication information and may indicate whether the AO agrees to share a capability exposure request with a second network that is, for example, a second public land mobile network, corresponding to the second network identifier.

The NEO-1 may generate a fourth request that is, for example, a network capability exposure request message, based on the sharing agreement information in the third response message received by the NEO-1 indicating that the AO agrees to share a capability exposure request with the second network. The fourth request may include an AO ID, second parameter information, and the like. The second parameter information may include a second Event ID, and may further include second reporting condition information. The second parameter information may further include traffic flow template information.

In some embodiments, 95a: The NEO-1 of the PLMN A transmits the fourth request to the NEO-2 of the PLMN B by using an interworking gateway-1 of the PLMN A and an interworking gateway-2 of the PLMN B sequentially.

In some embodiments, 95b: The NEO-1 of the PLMN A transmits the fourth request to the NEO-2 of the PLMN B.

After the NEO-2 receives the fourth request, authentication and verification are performed on the fourth request to generate a fourth response message.

In some embodiments, 96a: The NEO-2 of the PLMN B transmits the fourth response message to the NEO-1 of the PLMN A by using the interworking gateway-2 of the PLMN B and the interworking gateway-1 of the PLMN A sequentially.

In some embodiments, 96b: The NEO-2 of the PLMN B transmits the fourth response message to the NEO-1 of the PLMN A.

In some embodiments, 96c: The NEO-2 returns the fourth response message to the AO.

In some embodiments, 97: The NEO-1 returns the fourth response message to the AO.

Based on the AO agreeing to share the capability exposure request, the NEO-1 of the PLMN A completes a capability exposure sharing request process to the NEO-2 of the PLMN B. Based on the request process being completed, exposure information content (for example, capability exposure information) in the PLMN B may be notified to the AO by using the process in FIG. 5.

The network capability exposure method provided by some embodiments may implement negotiation of network capability exposure sharing between different PLMNs.

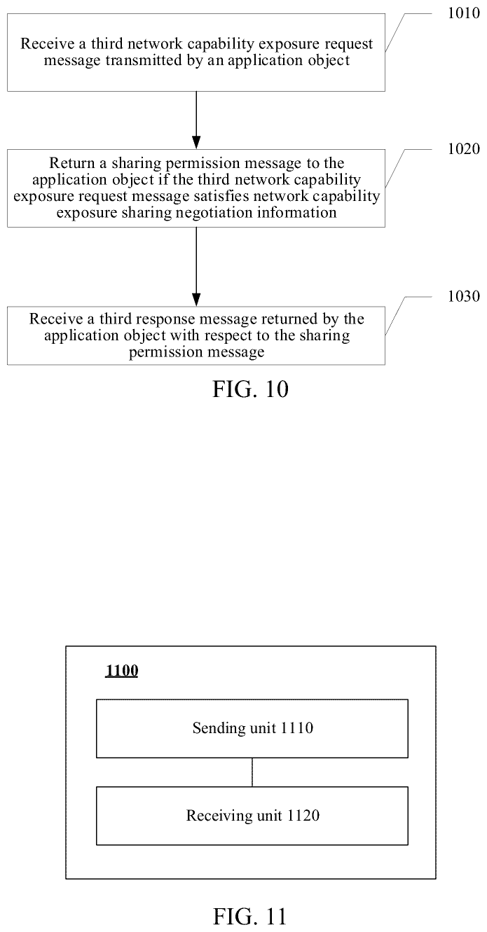

FIG. 10 is a schematic flowchart of a network capability exposure method according to some embodiments.

As shown in FIG. 10, the method according to some embodiments may be performed by a first exposure object of a first network that is, for example, a first public land mobile network. The method may include the following operations.

1010: Receive a third request that is, for example, a network capability exposure request message, transmitted by an application object. The third request may include an application object identifier, a notification address, and first parameter information.

1020: Return a sharing permission message to the application object if the third request satisfies network capability exposure sharing negotiation information. The sharing permission message may include a second network identifier indicating that sharing of a capability exposure request is allowed.

1030: Receive a third response message returned by the application object with respect to the sharing permission message. The third response message may include sharing agreement information. The sharing agreement information may be capability exposure request sharing indication information and may be configured for indicating whether the application object agrees to share a capability exposure request with a second network that is, for example, a second public land mobile network.

FIG. 11 is a block diagram of an application object according to some embodiments.

As shown in FIG. 11, an application object 1100 may include a sending unit 1110 and a receiving unit 1120.

The sending unit 1110 may be configured to transmit a first request that is, for example, a network capability exposure request message, to a first exposure object of a first network that is, for example, a first public land mobile network. The first request may include an application object identifier, a notification address, first parameter information, and sharing permission information.

In some embodiments, if the sharing permission information indicates that the application object allows to share the capability exposure request, the first request may further include a second network identifier indicating that sharing of the capability exposure request is allowed.

The receiving unit 1120 may be configured to receive a first response message returned by the first exposure object with respect to the first request. The first response message may include sharing agreement information. The sharing agreement information may be capability exposure request sharing indication information and may be configured for indicating whether the first exposure object agrees to share a capability exposure request with a second network that is, for example, a second public land mobile network.

In some embodiments, the receiving unit 1120 may be further configured to receive a second response message if the sharing agreement information indicates that the first exposure object agrees to share the capability exposure request with the second network. The second response message may include exposure agreement information. The exposure agreement information may be capability exposure indication information and may be configured for indicating whether a second exposure object of the second network agrees to expose a network capability to the application object.

In some embodiments, the receiving unit 1120 may be further configured to receive a capability exposure notification message of the second network if the exposure agreement information indicates that the second exposure object agrees to expose the network capability to the application object. The capability exposure notification message may include exposure information content.

In some embodiments, the receiving unit 1120 may be further configured to receive the capability exposure notification message from the first exposure object or the second exposure object.

In some embodiments, the receiving unit 1120 may be further configured to receive the capability exposure notification message from a first interworking gateway of the first network or a second interworking gateway of the second network.

In some embodiments, the first response message includes a first event identifier, and the first event identifier is configured for indicating that the first exposure object agrees the first request.

In some embodiments, the first parameter information may further include first reporting condition information.

In some embodiments, the first parameter information may further include traffic flow template information.

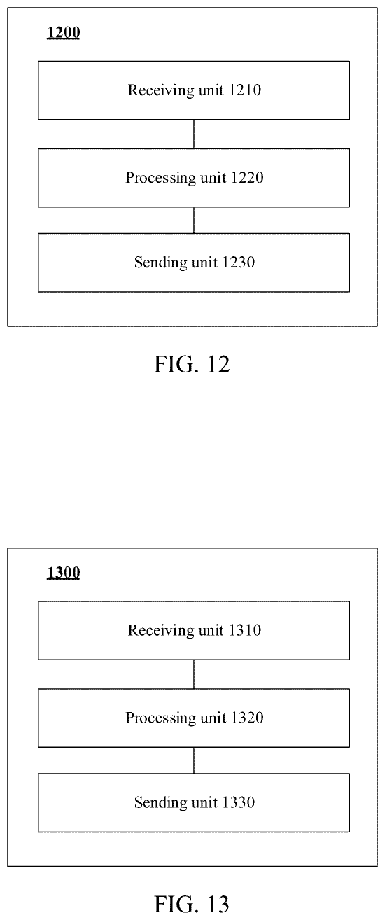

FIG. 12 is a block diagram of a first exposure object of a first network that is, for example, a first public land mobile network, according to some embodiments.

As shown in FIG. 12, a first exposure object 1200 according to some embodiments may include a receiving unit 1210, a processing unit 1220, and a sending unit 1230.

The receiving unit 1210 may be configured to receive a first request that is, for example, a network capability exposure request message, transmitted by an application object. The first request may include an application object identifier, a notification address, first parameter information, and sharing permission information.

In some embodiments, if the sharing permission information indicates that the application object allows to share the capability exposure request, the first request may further include a second network identifier indicating that sharing of the capability exposure request is allowed.

The processing unit 1220 may be configured to perform authentication and verification on the first request to generate a first response message. The first response message may include sharing agreement information. The sharing agreement information may be capability exposure request sharing indication information and may be configured for indicating whether the first exposure object agrees to share a capability exposure request with a second network that is, for example, a second public land mobile network.

The sending unit 1230 may be configured to return the first response message to the application object.

In some embodiments, the sending unit 1230 may be further configured to transmit a second request that is, for example, a network capability exposure request message, to a second exposure object of the second network if the sharing agreement information indicates that the first exposure object agrees to share the capability exposure request with the second network. The second request includes the application object identifier, the notification address, and second parameter information. The receiving unit 1210 may be further configured to receive a second response message with respect to the second request. The second response message includes exposure agreement information. The exposure agreement information may be capability exposure indication information and may be configured for indicating whether the second exposure object agrees to expose a network capability to the application object. The sending unit 1230 may be further configured to forward the second response message to the application object.

In some embodiments, the receiving unit 1210 may be further configured to receive a capability exposure notification message of the second network if the exposure agreement information indicates that the second exposure object agrees to expose the network capability to the application object, the capability exposure notification message including exposure information content. The sending unit 1230 may be further configured to transmit the capability exposure notification message to the application object.

In some embodiments, the second response message includes a second event identifier, and the second event identifier is configured for indicating that the second exposure object agrees the second request.

In some embodiments, the second parameter information may further include second reporting condition information.

In some embodiments, the sending unit 1230 may be further configured to transmit the second request to a first interworking gateway of the first network. The second request further includes a second network identifier and a first network identifier.

The second request may be configured for indicating the first interworking gateway to transmit, based on the second network identifier, the second request to a second interworking gateway of the second network.

The second request may be further configured for indicating the second interworking gateway to transmit the second request to the second exposure object.

FIG. 13 is a block diagram of a second exposure object of a second network that is, for example, a second public land mobile network, according to some embodiments.

As shown in FIG. 13, the second exposure object 1300 according to some embodiments may include a receiving unit 1310, a processing unit 1320, and a sending unit 1330.

The receiving unit 1310 may be configured to receive a second request that is, for example, a network capability exposure request message, transmitted by a first exposure object of a first network that is, for example, a first public land mobile network. The second request may include an application object identifier, a notification address, and second parameter information.

The processing unit 1320 may be configured to perform authentication and verification on the second request to generate a second response message. The second response message may include exposure agreement information. The exposure agreement information may be capability exposure indication information and may be configured for indicating whether the second exposure object agrees to expose a network capability to an application object.

The sending unit 1330 may be configured to return the second response message to the application object.

In some embodiments, the processing unit 1320 may be further configured to generate a capability exposure notification message of the second network if the exposure agreement information indicates that the second exposure object agrees to expose the network capability to the application object. The capability exposure notification message may include exposure information content. The sending unit 1330 may be further configured to transmit the capability exposure notification message of the second network to the application object.

Some embodiments further provides an application object, including a sending unit and a receiving unit.

The sending unit may be configured to transmit a third request that is, for example, a network capability exposure request message, to a first exposure object of a first network that is, for example, a first public land mobile network. The third request may include an application object identifier, a notification address, and first parameter information.

The receiving unit may be configured to receive a sharing permission message returned by the first exposure object. The sharing permission message may include a second network identifier indicating that sharing of a capability exposure request is allowed.

The sending unit may be further configured to return a third response message to the first exposure object with respect to the sharing permission message. The third response message may include sharing agreement information. The sharing agreement information may be capability exposure request sharing indication information and may be configured for indicating whether the application object agrees to share a capability exposure request with a second network that is, for example, a second public land mobile network.

In some embodiments, the receiving unit is further configured to receive a capability exposure notification message of the second network if the sharing agreement information indicates that the application object agrees to share the capability exposure request with the second network. The capability exposure notification message of the second network may include exposure information content.

Some embodiments provide a first exposure object of a first network that is, for example, a first public land mobile network, including a receiving unit and a sending unit.

The receiving unit may be configured to receive a third request that is, for example, a network capability exposure request message, transmitted by an application object. The third request may include an application object identifier, a notification address, and first parameter information.

The sending unit may be configured to return a sharing permission message to the application object if the third request satisfies network capability exposure sharing negotiation information. The sharing permission message may include a second network identifier indicating that sharing of a capability exposure request is allowed.

The receiving unit may be further configured to receive a third response message returned by the application object with respect to the sharing permission message. The third response message may include sharing agreement information. The sharing agreement information may be capability exposure request sharing indication information and may be configured for indicating whether the application object agrees to share a capability exposure request with a second network that is, for example, a second public land mobile network.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

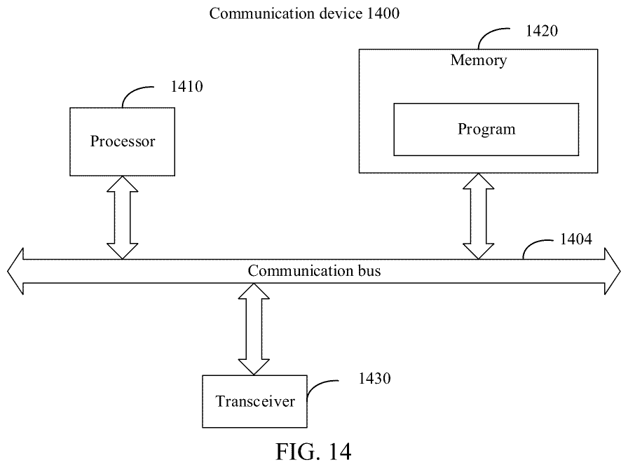

FIG. 14 is a schematic diagram of a structure of a communication device 1400 according to some embodiments. The communication device may be a terminal such as UE, a network device such as a base station, or an NEO and/or an AO and/or an interworking gateway. The communication device 1400 shown in FIG. 14 includes a processor 1410. The processor 1410 may call and run a computer program from a memory to implement the method according to some embodiments.

In some embodiments, as shown in FIG. 14, the communication device 1400 may further include a memory 1420. The processor 1410 may call and run a computer program from the memory 1420, to implement the method according to some embodiments.

The memory 1420 may be a separate device independent of the processor 1410, or may be integrated into the processor 1410.

In some embodiments, as shown in FIG. 14, the communication device 1400 may further include a transceiver 1430. The processor 1410 may control the transceiver 1430 to communicate with other devices, and for example, may send information or data to other devices or receive information or data from other devices.

The transceiver 1430 may include a transmitter and a receiver. The transceiver 1430 may further include one or more antennas.

The communication device 1400 may include various network elements, and the communication device 1400 may implement corresponding processes implemented by each network element in the methods of some embodiments.

The communication device 1400 may include the network device, and the communication device 1400 may implement corresponding processes implemented by the network device in the methods of some embodiments.

The communication device 1400 may include a mobile terminal/terminal, and the communication device 1400 may implement corresponding processes implemented by the mobile terminal/terminal in the methods of some embodiments.

The processor may be an integrated circuit chip and has a signal processing capability. In an implementation process, each operation may be completed by using an integrated logic circuit of hardware in the processor or instructions in the form of software.

The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The methods, operations, and logic block diagrams, according to some embodiments, may be implemented or performed. The general-purpose processor may be a microprocessor, or the processor may be any conventional processor, or the like. The operations of the methods disclosed with reference to some embodiments may be directly performed and completed by using a hardware decoding processor, or may be performed and completed by using a combination of hardware and software modules in the decoding processor. The software module may be stored in a storage medium that is mature in the art, such as a random access memory, a flash memory, a read-only memory, a programmable read-only memory, an electrically erasable programmable memory, or a register. The storage medium is located in the memory. The processor reads information in the memory and completes the operations of the methods in combination with hardware thereof.

The memory may be a volatile memory or a non-volatile memory, or may include a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) serving as an external cache. according to illustrative but not limited description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memory in the system and method, according to some embodiments, includes, but is not limited to, these memories and any other suitable types. The memory described above is illustrative but not limiting.

Some embodiments provide a computer-readable storage medium, configured to store a computer program.

The computer-readable storage medium may be used in the network device, and the computer program causes a computer to execute corresponding processes implemented by the network device in the methods of some embodiments.

The computer-readable storage medium may be used in the network element, and the computer program causes a computer to execute corresponding processes implemented by the network element in the methods of some embodiments.

The computer-readable storage medium may be used in the mobile terminal/terminal, and the computer program causes a computer to execute corresponding processes implemented by the mobile terminal/terminal in the methods of some embodiments.

Some embodiments provide a computer program product, including computer program instructions.

The computer program product may be used in the network device, and the computer program instructions cause a computer to execute corresponding processes implemented by the network device in the methods of some embodiments.

The computer program product may be used in the network element, and the computer program instructions cause a computer to execute corresponding processes implemented by the network element in the methods of some embodiments.

The computer program product may be used in the mobile terminal/terminal, and the computer program instructions cause a computer to execute corresponding processes implemented by the mobile terminal/terminal in the methods of some embodiments.

Some embodiments provide a computer program.

The computer program may be used in the network device. When the computer program is run on a computer, the computer is enabled to execute corresponding processes implemented by the network device in the methods of some embodiments.

The computer program may be used in the network element. When the computer program is run on a computer, the computer is enabled to execute corresponding processes implemented by the network element in the methods of some embodiments.

The computer program may be used in the mobile terminal/terminal. When the computer program is run on a computer, the computer is enabled to execute corresponding processes implemented by the mobile terminal/terminal in the methods of some embodiments.

A person of ordinary skill in the art may notice that the exemplary units and algorithm operations described with reference to some embodiments can be implemented in electronic hardware, or a combination of computer software and electronic hardware. Whether the functionality is executed in a mode of hardware or software depends on the applications and design constraint conditions. A person skilled in the art may use different methods to implement the described functionality for each application, but the implementation would not go beyond the scope of the disclosure.

A person skilled in the art may clearly understand that, for work processes of the foregoing described system, apparatus, and unit, reference may be made to corresponding processes in some embodiments.

In some embodiments, the system, apparatus, and method may be implemented in other manners. For example, some embodiments are schematic, the unit division is logical division, and there may be other division in actual implementation. For example, a plurality of units or components may be combined or integrated into another system.

The units described as separate parts may or may not be physically separate, and components displayed as units may or may not be physical units, and for example, may be located in one position, or may be distributed on a plurality of network units. Some or all of the units may be selected according to actual needs to implement some embodiments.

In addition, functional units in some embodiments may be integrated into one processing unit, or each of the units may exist alone physically, or two or more units may be integrated into one unit. If implemented in the form of software functional units and sold or used as an independent product, the functions may be stored in a computer-readable storage medium. Based on such an understanding, the technical solutions of the present disclosure, or the part contributing to the related art, or some of the technical solutions may be implemented in the form of a software product. The computer software product is stored in a storage medium and includes several instructions for instructing a computer device (which may be a personal computer, a server, a network device, or the like) to perform all or some of the operations of the methods described according to some embodiments. The foregoing storage medium includes any medium that can store program code, such as a USB flash drive, a removable hard disk, a read-only memory (ROM), a random access memory (RAM), a magnetic disk, or an optical disc.

The foregoing embodiments are used for describing, instead of limiting the technical solutions of the disclosure. A person of ordinary skill in the art shall understand that although the disclosure has been described in detail with reference to some embodiments, modifications can be made to the technical solutions described in some embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A network capability exposure method, performed by an application object, comprising:
transmitting a first request to a first exposure object of a first network; and
receiving a first response returned by the first exposure object,
wherein the first request is a capability exposure request including an application object identifier, a notification address, first parameter information, and sharing permission information,
wherein the first response includes sharing agreement information indicating whether the first exposure object agrees to share the first request with a second network, and
wherein the first network and the second network are each public land mobile networks.

2. The method according to claim 1, wherein based on the sharing permission information indicating the application object allows the first request to be shared, the first request further includes a second network identifier corresponding to the second network.

3. The method according to claim 1, further comprising:
receiving a second response based on the sharing agreement information indicating the first exposure object agrees to share the first request with the second network,
wherein the second response includes first exposure agreement information indicating whether a second exposure object of the second network agrees to expose a network capability to the application object.

4. The method according to claim 3, further comprising:
receiving an exposure notification of the second network based on the first exposure agreement information indicating the second exposure object agrees to expose the network capability to the application object,
wherein the exposure notification includes exposure information content.

5. The method according to claim 1, wherein the first response includes a first event identifier indicating the first exposure object agrees to the first request.

6. The method according to claim 1, wherein the first response is generated by the first exposure object based on an authentication and verification result of the first request.

7. The method according to claim 3, wherein the first exposure object transmits a second request to the second exposure object based on the sharing agreement information indicating the first exposure object agrees to share the first request with the second network,
wherein the second request includes the application object identifier, the notification address, and second parameter information,
wherein the first exposure object receives the second response from the second exposure object, and
wherein the receiving the second response further comprises receiving the second response as forwarded from the first exposure object.

8. The method according to claim 4, wherein the first exposure object receives the exposure notification from the second exposure object, and
wherein the receiving the exposure notification further comprises receiving the exposure notification as forwarded from the first exposure object.

9. The method according to claim 7, wherein the second response further includes a second event identifier indicating the second exposure object agrees to the second request.

10. The method according to claim 7, wherein the second request further includes a second network identifier corresponding to the second network and a first network identifier corresponding to the first network,
wherein the first exposure object transmits the second request to the second exposure object via a first interworking gateway of the first network and a second interworking gateway of the second network,
wherein the first interworking gateway receives the second request from the first exposure object and transmits the second request to the second interworking gateway of the second network based on the second network identifier, and
wherein the second interworking gateway receives the second request from the first interworking gateway from the first interworking gateway and transmits the second request to the second exposure object.

11. A communication device, comprising:
at least one memory configured to store computer program code;
at least one processor configured to read the program code and operate as instructed by the program code, the program code comprising:
first transmitting code configured to cause at least one of the at least one processor to transmit a first request to a first exposure object of a first network; and
first receiving code configured to cause at least one of the at least one processor to receive a first response returned by the first exposure object,
wherein the first request is a capability exposure request, comprising:
a communication device identifier;
a notification address;
first parameter information; and
sharing permission information,
wherein the first response comprises sharing agreement information indicating whether the first exposure object agrees to share the first request with a second network, and
wherein the first network and the second network are each public land mobile networks.

12. The communication device according to claim 11, wherein based on the sharing permission information indicating the communication device allows the first request to be shared, the first request further comprises a second network identifier corresponding to the second network.

13. The communication device according to claim 11, wherein the program code further comprises second receiving code configured to cause at least one of the at least one processor to receive a second response based on the sharing agreement information indicating the first exposure object agrees to share the first request with the second network, and
wherein the second response comprises first exposure agreement information indicating whether a second exposure object of the second network agrees to expose a network capability to the communication device.

14. The communication device according to claim 13, wherein the program code further comprises third receiving code configured to cause at least one of the at least one processor to receive an exposure notification of the second network based on the first exposure agreement information indicating the second exposure object agrees to expose the network capability to the communication device, and
wherein the exposure notification comprises exposure information content.

15. The communication device according to claim 11, wherein the first response comprises a first event identifier indicating the first exposure object agrees to the first request.

16. The communication device according to claim 11, wherein the first response is generated by the first exposure object based on an authentication and verification result of the first request.

17. The communication device according to claim 13, wherein the first exposure object is configured to transmit a second request to the second exposure object based on the sharing agreement information indicating the first exposure object agrees to share the first request with the second network,
wherein the second request comprises:
the communication device identifier,
the notification address, and
second parameter information,
wherein the first exposure object is configured to receive the second response from the second exposure object, and
wherein the second receiving code is further configured to cause at least one of the at least one processor to receive the second response as forwarded from the first exposure object.

18. The communication device according to claim 14, wherein the first exposure object is configured to receive the exposure notification from the second exposure object, and
wherein the third receiving code is further configured to cause at least one of the at least one processor to receive the exposure notification as forwarded from the first exposure object.

19. The communication device according to claim 17, wherein the second response further comprises a second event identifier indicating the second exposure object agrees to the second request.

20. A non-transitory computer-readable storage medium, storing computer code which, when executed by at least one processor, cause the at least one processor to at least:
transmit a first request to a first exposure object of a first network; and
receive a first response returned by the first exposure object,
wherein the first request is a capability exposure request, comprising:
an application object identifier;
a notification address;
first parameter information; and
sharing permission information,
wherein the first response comprises sharing agreement information indicating whether the first exposure object agrees to share the first request with a second network, and
wherein the first network and the second network are each public land mobile networks.
